(19) United States
(12) Patent Application Publication
(10) Pub. No.: US 2023/0205105 A1
(43) Pub. Date: Jun. 29, 2023

(54) TONER, IMAGE FORMING APPARATUS, IMAGE FORMATION METHOD, AND PRINTED MATTER MANUFACTURING METHOD

(71) Applicants: Yoshitaka YAMAUCHI, Shizuoka (JP); Kohtaroh OGINO, Shizuoka (JP); Masayuki ISHII, Shizuoka (JP); Ayaka MORI, Shizuoka (JP)

(72) Inventors: Yoshitaka YAMAUCHI, Shizuoka (JP); Kohtaroh OGINO, Shizuoka (JP); Masayuki ISHII, Shizuoka (JP); Ayaka MORI, Shizuoka (JP)

(21) Appl. No.: 18/081,701

(22) Filed: Dec. 15, 2022

(30) Foreign Application Priority Data
Dec. 27, 2021 (JP) 2021-213213

(51) Int. Cl. G03G 9/087; G03G 15/08

(52) U.S. Cl. CPC G03G 9/08755; G03G 9/08782; G03G 9/08795; G03G 9/08797; G03G 15/0896

(57) ABSTRACT

A toner including a non-crystalline polyester resin, a crystalline polyester resin, a hydrocarbon wax, and an aromatic petroleum resin is provided. A mass ratio of the aromatic petroleum resin to the hydrocarbon wax is 1.0 or more. The non-crystalline polyester resin contains diol components, and the diol components include an alkylene oxide adduct of bisphenol A and ethylene glycol.

### CROSS-REFERENCE TO RELATED APPLICATIONS

This patent application is based on and claims priority pursuant to 35 U.S.C. § 119(a) to Japanese Patent Application No. 2021-213213, filed on Dec. 27, 2021, in the Japan Patent Office, the entire disclosure of which is hereby incorporated by reference herein.

### BACKGROUND

### Technical Field

The present disclosure relates to a toner, an image forming apparatus, an image formation method, and a printed matter manufacturing method.

Recently, toners have been required to have excellent pulverizability for environmental consideration. To improve pulverizability, not only manufacturing processes but also material design should be well considered. For a purpose of reducing volatile components from fine particles, in addition to a conventional purpose of saving energy, low-temperature fixability should be improved. In particular, heat-resistant storage stability and durability in actual machines are required.

In recent years, electrophotographic systems have been widely used in various applications, e.g., office applications and mass printing. Specifically, in continuous duplex printing, the occurrence of blocking, caused due to high-temperature environment after the process of sheet ejection, should be prevented.

### SUMMARY

One aspect of the present invention is a toner including a non-crystalline polyester resin, a crystalline polyester resin, a hydrocarbon wax, and an aromatic petroleum resin. A mass ratio of the aromatic petroleum resin to the hydrocarbon wax is 1.0 or more. The non-crystalline polyester resin contains diol components, and the diol components include an alkylene oxide adduct of bisphenol A and ethylene glycol.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an image forming apparatus according to an embodiment of the present invention;

FIG. 2 is a schematic diagram illustrating an image forming apparatus according to an embodiment of the present invention; and

FIG. 3 is a schematic diagram illustrating an image forming apparatus according to an embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure will be described below.

A toner, an image forming apparatus, an image formation method, and a printed matter manufacturing method according to the present disclosure will be described with reference to the drawings. The present disclosure is not limited to the embodiment described below, may be another embodiment, and may be subject to changes such as additions, modifications, and omissions within the scope conceivable for a person skilled in the art. All of these changed configurations are also included in the scope of the present disclosure as long as an operation and an effect of the present disclosure is exhibited.

According to one aspect of the present disclosure, a toner having excellent pulverizability, low-temperature fixability, and heat-resistant storage stability is provided.

<Toner>

A toner according to the present embodiment contains at least a non-crystalline polyester resin, a crystalline polyester resin, a hydrocarbon wax, and an aromatic petroleum resin.

<<Non-Crystalline Polyester Resin>>

The non-crystalline polyester resin used in the toner of the present disclosure contains diol components, and the diol components include an alkylene oxide adduct of bisphenol A and ethylene glycol. In the present disclosure, diol is meant to include aliphatic diol, alicyclic diol, and aromatic diol. The alkylene oxide adduct of bisphenol A is obtained by polymerizing bisphenol A with an alkylene oxide being a cyclic ether.

A content of the non-crystalline polyester resin in the toner is not particularly limited, but is preferably 65% by mass or more and 90% by mass, more preferably 70% by mass or more and 85% by mass, and still more preferably 75% by mass or more and 80% by mass.

A content of the diol components in the non-crystalline polyester resin is not particularly limited, but is preferably 35% by mass or more and 65% by mass, more preferably 40% by mass or more and 60% by mass, and still more preferably 45% by mass or more and 55% by mass.

Contents of the alkylene oxide adduct of bisphenol A and the ethylene glycol in the diol components are not particularly limited, but a mass ratio of the alkylene oxide adduct of bisphenol A relative to the ethylene glycol in the diol components is preferably 0.7 to 2.3, more preferably 1 to 2, and still more preferably 1.3 to 1.7.

When the diol components included in the non-crystalline polyester resin contain the alkylene oxide adduct of bisphenol A, the toner is imparted with good heat resistance. When the diol components contain the ethylene glycol, the toner may hold good dispersibility with the hydrocarbon wax. As a result, the toner of the present disclosure is excellent in pulverizability, low-temperature fixability, and heat-resistant storage stability.

The alkylene oxide adduct of bisphenol A contained as the diol component in the non-crystalline polyester resin preferably includes at least one of an ethylene oxide adduct of bisphenol A and a propylene oxide adduct of bisphenol A, and more preferably includes the ethylene oxide adduct of bisphenol A and the propylene oxide adduct of bisphenol A.

When the alkylene oxide adduct of bisphenol A includes the ethylene oxide adduct of bisphenol A and the propylene oxide adduct of bisphenol A, a mass ratio between the ethylene oxide adduct of bisphenol A and the propylene oxide adduct of bisphenol A is not particularly limited, but the mass ratio of the ethylene oxide adduct of bisphenol A relative to the propylene oxide adduct of bisphenol A in the diol components is preferably 3 to 7, more preferably 4 to 6, and still more preferably 4.5 to 5.5.

When the diol components in the non-crystalline polyester resin include at least one of the ethylene oxide adduct of bisphenol A and the propylene oxide adduct of bisphenol A, pulverizability, low-temperature fixability, and heat-resistant storage stability can be improved.

The non-crystalline polyester resin used in the toner of the present disclosure may contain another diol component other than the alkylene oxide adduct of bisphenol A and ethylene glycol.

Examples of the other diol component include, but are not limited to, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, cyclohexanediol, bisphenol A, and hydrogenated bisphenol A.

As a cross-linker for the non-crystalline polyester resin, a polyol having 3 or more valences may be used in combination. Examples of the polyol having 3 or more valences include, but are not limited to, sorbitol, 1,2,3,6-hexanetetrol, 1,4-sorbitan, pentaerythritol, dipentaerythritol, tripentaerythritol, 1,2,4-butanetriol, 1,2,5-pentatriol, glycerol, 2-methylpropanetriol, 2-methyl-1,2,4-butanetriol, trimethylolethane, trimethylolpropane, and 1,3,5-trihydroxybenzene.

Examples of an acid component of the non-crystalline polyester resin include, but are not limited to, benzenedicarboxylic acids such as phthalic acid, isophthalic acid, and terephthalic acid or anhydride thereof; alkyldicarboxylic acids such as succinic acid, adipic acid, sebacic acid, and azelaic acid or anhydride thereof; unsaturated dibasic acid anhydride such as maleic acid, citraconic acid, itaconic acid, alkenyl succinic acid, fumaric acid, and mesaconic acid; and unsaturated dibasic acid anhydride such as maleic anhydride, citraconic anhydride, itaconic anhydride, and alkenylsuccinic anhydride.

Examples of the acid component of the non-crystalline polyester resin further include trivalent or higher polycarboxylic acid components such as trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, tetra(methylenecarboxy)methane, 1,2,7,8-octanetetracarboxylic acid, empol trimer acid; or anhydrides thereof, and partially lower alkyl esters thereof.

An acid value of the non-crystalline polyester resin is preferably 0.1 mgKOH/g or more and 100 mgKOH/g or less, more preferably 0.1 mgKOH/g or more and 70 mgKOH/g or less, and still more preferably 0.1 mgKOH/g or more and 50 mgKOH/g or less. When the acid value of the non-crystalline polyester resin is 0.1 mgKOH/g or more and 100 mgKOH/g or less, the non-crystalline polyester resin can function as a binder resin.

In the toner of the present disclosure, a molecular weight distribution of the non-crystalline polyester resin is measured by gel permeation chromatography (GPC) using tetrahydrofuran (THF) as a solvent.

<<Crystalline Polyester Resin>>

The toner of the present disclosure contains a crystalline polyester resin. The toner containing the crystalline polyester resin is imparted with good low-temperature fixability.

A melting point of the crystalline polyester resin used in the toner of the present disclosure is preferably 90° C. to 130° C., more preferably 95° C. or higher and 125° C. or lower, and still more preferably 100° C. to 120° C.

The crystalline polyester partially has a non-crystallized part, and a glass transition temperature of such a part rises according to the melting point. When the glass transition temperature of the non-crystallized part and the glass transition temperature of the non-crystalline polyester resin are closer to each other, the compatibility is higher and the low-temperature fixability is higher. For the above reasons, it is preferable that the melting point of the crystalline polyester resin is 90° C. or higher because the low-temperature fixability is improved.

If the melting point of the crystalline polyester resin is too high, the crystalline polyester resin may be melted insufficiently with an amount of heat at the time of fixing, possibly impairing the low-temperature fixability. For the above reasons, it is preferable that the melting point of the crystalline polyester resin is 120° C. or lower because deterioration of the low-temperature fixability can be prevented.

The crystalline polyester resin may be manufactured by a polycondensation reaction between (I) a polycarboxylic acid component comprising a linear unsaturated aliphatic divalent carboxylic acid or a reactive derivative (for example, acid anhydride, lower alkyl ester having 1 to 4 carbon atoms, and acid halide) thereof, and (II) a polyhydric alcohol component comprising a linear aliphatic diol, according to a conventional method.

If desired, a small amount of another polycarboxylic acid may be added to the polycarboxylic acid component used for producing the crystalline polyester resin. The polycarboxylic acid in this case includes: (i) an unsaturated aliphatic dicarboxylic acid having a branched chain; (ii) a saturated aliphatic polycarboxylic acid such as a saturated aliphatic divalent carboxylic acid and a saturated aliphatic trivalent carboxylic acid; and (iii) an aromatic polyvalent carboxylic acid such as an aromatic divalent carboxylic acid and an aromatic trivalent carboxylic acid.

A usual amount of such polyvalent carboxylic acids to be added relative to the total amount of carboxylic acids is 30 mol % or less, preferably 20 mol % or less, and more preferably 10 mol % or less, and such polyvalent carboxylic acids are added as appropriate within a range in which the resultant polyester has crystallinity.

Examples of the polyvalent carboxylic acid to be added as desired may include, but are not limited to: divalent carboxylic acid such as malonic acid, succinic acid, glutaric acid, adipic acid, suberic acid, sebacic acid, citraconic acid, phthalic acid, isophthalic acid, and terephthalic acid; and trivalent or higher polyvalent carboxylic acids such as trimellitic anhydride, 1,2,4-benzenetricarboxylic acid, 1,2,5-benzenetricarboxylic acid, 1,2,4-cyclohexanetricarboxylic acid, 1,2,4-naphthalenetricarboxylic acid, 1,2,5-hexanetricarboxylic acid, 1,3-dicarboxyl-2-methylenecarboxypropane, and 1,2,7,8-octanetetracarboxylic acid.

The polyhydric alcohol component may be added with a small amount of aliphatic branched chain dihydric alcohol, a cyclic dihydric alcohol, and/or a trihydric or higher polyhydric alcohol, if desired. The amount to be added relative to the total amount of alcohols is 30 mol % or less, preferably 20 mol % or less, and more preferably 10 mol % or less, and the alcohols are added as appropriate within a range in which the resultant polyester has crystallinity.

Examples of the polyhydric alcohol to be added as desired include, but are not limited to, 1,4-bis(hydroxymethyl)cyclohexane, polyethylene glycol, bisphenol A ethylene oxide adduct, bisphenol A propylene oxide adduct, and glycerin.

Preferably, the crystalline polyester resin has a sharp molecular weight distribution, from the viewpoint of low-temperature fixability, and a low molecular weight. The molecular weight of the crystalline polyester resin preferably has a weight average molecular weight (Mw) of 5500 to 6500, a number average molecular weight (Mn) of 1300 to 1500, and a Mw/Mn ratio of 2 to 5, as obtained from a molecular weight distribution of o-dichlorobenzene soluble matter of the crystalline polyester resin.

The molecular weight distribution of the crystalline polyester resin is based on a molecular weight distribution chart in which the horizontal axis is log M (M is molecular weight) and the vertical axis is mass %. In such a molecular weight distribution chart, the crystalline polyester resin used in the toner of the present disclosure preferably has a molecular weight peak in the range of 3.5% to 4.0% by mass, and a half value width of such a peak is preferably 1.5 or less.

<<Hydrocarbon Wax>>

The toner of the present disclosure contains a hydrocarbon wax. The hydrocarbon wax has a relatively high melting point, and thus, the toner containing the hydrocarbon wax has excellent heat resistance and anti-blocking property.

The hydrocarbon wax may be either synthetic wax or natural wax. Examples of the hydrocarbon wax include, but are not limited to, paraffin wax, microcrystalline wax, Fischer Tropsch wax, polyethylene wax, and polypropylene wax. In particular, Fischer Tropsch wax is preferable from the viewpoint of improving the heat resistance and anti-blocking property of the toner.

A melting point of the hydrocarbon wax is not particularly limited, but is preferably 75° C. or higher and 100° C. or lower, and more preferably 80° C. or higher and 95° C. or lower. When the melting point of the hydrocarbon wax is 75° C. or higher, the anti-blocking effect is exerted in the toner. When the melting point of the hydrocarbon wax is 100° C. or lower, the low-temperature fixability of the toner is prevented from being inhibited.

The content of the hydrocarbon wax in the toner is preferably 4.5% by mass or more and 6.5% by mass or less, and more preferably 5% by mass or more and 6% by mass or less. When the content of the hydrocarbon wax is 4.5% by mass or more, releasability is imparted to the toner during fixing. When the content of the hydrocarbon wax is 6.5% by mass or less, deterioration in durability of the toner due to excessive wax can be prevented.

<<Aromatic Petroleum Resin>>

The toner of the present disclosure contains an aromatic petroleum resin. The toner containing the aromatic petroleum resin improves pulverizability, and heat resistance while maintaining the low-temperature fixability.

In the present disclosure, the aromatic petroleum resin is a resin obtained by synthesizing raw materials including styrene, vinyl toluene, and indene, which are C9 fractions of petroleum. In particular, from among such aromatic petroleum resins, a styrene-based copolymer is preferable from the viewpoint of improving wax dispersibility and toner durability.

Examples of the styrene-based copolymer include, but are not limited to, a polymer of styrene and a substituted product thereof such as polystyrene, poly-p-styrene, and polyvinyltoluene, a styrene-α-methylstyrene copolymer, a styrene-p-chlorostyrene copolymer, a styrene-propylene copolymer, a styrene-vinyl toluene copolymer, a styrene-methyl acrylate copolymer, a styrene-ethyl acrylate copolymer, a styrene-butyl acrylate copolymer, a styrene-methyl methacrylate copolymer, a styrene-ethyl methacrylate copolymer, a styrene-butyl methacrylate copolymer, a styrene-α-methyl chloromethacrylate copolymer, a styrene-acrylonitrile copolymer, a styrene-vinyl methyl ether copolymer, a styrene-methyl vinyl ketone copolymer, a styrene-butadiene copolymer, a styrene-isoprene copolymer, a styrene-maleic acid copolymer, and a styrene-maleic acid ester copolymer. In particular, the styrene-α-methylstyrene copolymer is preferable among them for the styrene-based copolymer.

A glass transition temperature (Tg) of the styrene-based copolymer is preferably 60° C. or higher, and more preferably 65 to 85° C. When the Tg of the styrene resin is 60° C. or higher, the heat-resistant storage stability is improved.

Tg is measured by using a differential scanning calorimeter (Q-200, manufactured by TA Instruments). Specifically, after about 5.0 mg of a target sample is placed in an aluminum sample container, the sample container is placed on the holder unit and set in an electric furnace, next, under nitrogen atmosphere, a temperature is raised from −80° C. to 150° C. at a temperature elevation rate of 10° C./min, and from an obtained DSC curve, the glass transition temperature (Tg) of the target sample is evaluated by using an analysis program in a differential scanning calorimeter.

In the toner of the present disclosure, a mass ratio of the aromatic petroleum resin relative to the hydrocarbon wax is preferably 1.0 or more. When the ratio is 1.0 or more, wax dispersibility and toner durability are well maintained.

A weight average molecular weight of the aromatic petroleum resin is preferably 1000 or more and 4000 or less, more preferably 1300 or more and 3800 or less, and still more preferably 1500 or more and 3700 or less. When the weight average molecular weight of the aromatic petroleum resin is 1000 or more, the toner exerts durability in an actual machine. When the weight average molecular weight of the aromatic petroleum resin is 4000 or less, the toner has good pulverizability.

The toner of the present disclosure may contain a colorant, a charge control agent, and an external additive as desired.

<<Colorant>>

All well-known dyes and pigments may be employed for the colorant used in the toner of the present disclosure.

Examples of the colorant may include, but are not limited to, carbon black, nigrosine dye, iron black, naphthol yellow S, Hansa yellow (10G, 5G, G), cadmium yellow, yellow iron oxide, ocher, yellow lead, titanium yellow, polyazo yellow, Oil Yellow, Hansa yellow (GR, A, RN, R), Pigment Yellow L, benzidine yellow (G, GR), permanent yellow (NCG), Vulcan Fast Yellow (5G, R), Tartrazine Lake, Quinoline Yellow Lake, Anthrazane Yellow BGL, Isoindolinone Yellow, red iron oxide, red lead, lead red, cadmium red, cadmium mercury red, antimony vermilion, permanent red 4R, Para Red, Faise Red, parachlor orthonitro aniline red, Resol Fast Scarlet G, Brilliant Fast Scarlet, Brilliant Carmine BS, permanent red (F2R, F4R, FRL, FRLL, F4RH), Fast Scarlet VD, Vulcan Fast Rubin B, Brilliant Scarlet G, Lithol Rubin GX, permanent red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarin Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS, BC), Indigo, ultramarine, dark blue, Anthraquinone Blue, Fast Violet B, Methyl Violet Lake, cobalt purple, manganese purple, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and mixtures thereof.

The content of the colorant relative to the toner is preferably 1% by mass or more and 15% by mass or less, and more preferably 3% by mass or more and 10% by mass or less.

The colorant used in the toner of the present disclosure may be employed as a masterbatch compounded with a resin. The non-crystalline polyester resin used as the above-described binder resin may be employed for a binder resin to be kneaded together with the masterbatch. The binder resin may be used singly or in combination with others.

The masterbatch may be obtained by mixing and kneading a resin and a colorant for masterbatch preparation with a high shearing force. At this time, to increase interaction between the colorant and the resin, an organic solvent may be employed. In a method in which an aqueous paste containing water of a colorant is mixed and kneaded with a resin and an organic solvent and the colorant is transferred to a resin side to remove a moisture and an organic solvent component, which is referred to as flushing method, a wet cake of the colorant as is may be used to eliminate a dry process, and hence, this method is suitably used.

When the aqueous paste is mixed and kneaded, a high shearing force dispersing device such as a three roll mill may be suitably used. An amount of the masterbatch to be used is preferably 0.1 to 20 parts by mass with respect to 100 parts by mass of the binder resin.

The resin for masterbatch preparation more preferably has an acid value of 30 mgKOH/g or less, an amine value of 1 to 100, and is used with a colorant dispersed therein, and more preferably has an acid value of 20 mgKOH/g or less, an amine value of 10 to 50, and is used with a colorant dispersed therein.

If the acid value exceeds 30 mgKOH/g, chargeability under high humidity may be lowered and pigment dispersibility may be insufficient. If the amine value is less than 1 and if the amine value exceeds 100, the pigment dispersibility may be insufficient. It is noted that the acid value may be measured by a method described in JIS K0070, and the amine value may be measured by a method described in JIS K7237.

A dispersant may be employed to enhance the dispersibility of the pigment. The dispersant preferably has high compatibility with the binder resin in terms of pigment dispersibility, and examples of commercially available products may include, but are not limited to, “Ajisper (registered trademark) PB821”, “Ajisper PB822” (manufactured by Ajinomoto Fine-Techno Co., Inc.), “Disperbyk (registered trademark)-2001” (manufactured by BYK-Chemie), and “EFKA-4010” (manufactured by EFKA).

In a mass average molecular weight of the dispersant, a molecular weight of a maximum value of a main peak in terms of styrene mass in GPC is preferably 500 to 100,000, preferably 3,000 to 100,000 from the viewpoint of pigment dispersibility, more preferably 5,000 to 50,000, and particularly preferably 5,000 to 30,000.

When the weight average molecular weight of the dispersant is less than 500, the polarity may be high, and thus, the dispersibility of the colorant may deteriorate. When the weight average molecular weight of the dispersant exceeds 100,000, the affinity with the solvent may increase, and thus, the dispersibility of the colorant may deteriorate.

The dispersant is preferably blended in the toner at a ratio of 0.1% by mass or more and 10% by mass or less with respect to the colorant. If the blending ratio of the dispersant is less than 0.1% by mass, the pigment dispersibility may be insufficient, and if such a ratio is more than 10% by mass, the chargeability under high humidity may be lowered.

<<Charge Control Agent>>

All well-known charge control agents may be employed for the toner of the present disclosure. However, a white or light-colored charge control agent is preferred for a color toner. When a colored charge control agent is used, the content is desirably reduced to prevent the toner from being mixed with color to make the toner color dull.

Examples of the charge control agents include, but are not limited to, nigrosine dyes, triphenylmethane dyes, chromium-containing metal complex dyes, chelate pigments of molybdic acid, Rhodamine dyes, alkoxyamines, quaternary ammonium salts (including fluorine-modified quaternary ammonium salts), alkylamides, phosphor and phosphor-containing compounds, tungsten and tungsten-containing compounds, fluorine active agents, metal salts of salicylic acid, and metal salts of salicylic acid derivatives.

Specific examples of the charge control agents include, but are not limited to, a nigrosine dye, BONTRON 03; a quaternary ammonium salt, BONTRON P-51; a metal-containing azo dye, BONTRON S-34; an oxynaphthoic acid-based metal complex, E-82; a salicylic acid-based metal complex, E-84; a phenolic condensate, E-89 (all of which are manufactured by Orient Chemical Industry Co., Ltd.); a quaternary ammonium salt molybdenum complex, TP-302, TP-415 (manufactured by Hodogaya Chemical Industry Co., Ltd.); a quaternary ammonium salt, COPY CHARGE PSY VP2038; a triphenylmethane derivative, COPY BLUE PR; a quaternary ammonium salt, COPY CHARGE NEG VP2036; COPY CHARGE NX VP434 (all of which are manufactured by Hoechst); LRA-901; a boron complex, LR-147 (manufactured by Nippon Carlit Co., Ltd.); copper phthalocyanine; perylene; quinacridone; azo pigments; and a polymeric compound having a functional group such as a sulfonic acid group, a carboxyl group, and a quaternary ammonium salt.

The content of the charge control agent in the toner of the present disclosure is determined by a type of binder resin, presence or absence of an additive used as desired, and a toner preparing method including a dispersion method, is not uniquely limited, but the charge control agent is preferably used in the range of 0.1 to 10% by mass with respect to 100% by mass of the binder resin, and more preferably used in the range of 0.2 to 5% by mass.

If the content of the charge control agent exceeds 10% by mass, chargeability of toner is too large, and thus, the effect of the charge control agent is reduced, an electrostatic attraction force with a developing roller increases, decrease in fluidity of the developer and a decrease in image density occur. Such charge control agents and release agents may be melted and kneaded with the masterbatch and the resin.

<<External Additive>>

To improve fluidity, storability, developability, transferability, and durability of the toner, toner base particles may be added and mixed with inorganic fine particles such as oxide fine particles and hydrophobic silica fine powder, and polymeric resin fine particles, as an external additive. When wax allowing for reduction of the transferability and durability is fully covered with such external additives and a contact area is decreased due to the toner surface being covered with fine particles, such an effect is obtained.

Surfaces of such inorganic fine particles are preferably hydrophobized, and metal oxide fine particles such as hydrophobized silica and titanium oxide are suitably used. When an external addition amount of hydrophobized titanium oxide is increased than an external addition amount of hydrophobized silica, it is possible to obtain a toner excellent in charging stability against humidity, with an improved toner transfer rate and a good filming resistance.

A primary particle diameter of the inorganic fine particles and the resin fine particles is preferably 5 nm to 2 μm. A proportion of the inorganic fine particles to be used is in the range of 0.01 to 5 mass % with respect to the toner particles, depending on the type. Here, the primary particle size indicates an average value of a volume average primary particle size (number-based average primary particle size) evaluated from a transmission electron micrograph (TEM image) or a scanning electron micrograph (SEM image) of particles.

Specific examples of the inorganic fine particles include, but are not limited to, silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, pengalla, antimony trioxide, magnesium oxide, zirconium oxide, barium sulfate, barium carbonate, calcium carbonate, silicon carbide, and silicon nitride. Such inorganic fine particles may be used singly or in combination with others.

Examples of the polymeric resin fine particles include, but are not limited to, polystyrene, an ester of methacrylic acid, and an acrylic ester copolymer obtained by soap-free emulsion polymerization, suspension polymerization, and dispersion polymerization; a polycondensation system such as silicone, benzoguanamine, and nylon; and polymer particles including a thermosetting resin.

In particular, when a glycerin fatty acid ester or a polyglycerin fatty acid ester is employed for the release agent in addition to ketone wax, it is preferable to use silica and titanium oxide together. The silica and titanium oxide are strongly negatively charged, and in the absence of an external additive, positively charged particles can be changed to be negatively charged.

Representative examples of the hydrophobizing agent for hydrophobizing the surface of inorganic fine particles include, but are not limited to, dimethyldichlorosilane, trimethylchlorosilane, methyltrichlorosilane, allyldimethyldichlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, chloromethyltrichlorosilane, p-chlorophenyltrichlorosilane, 3-chloropropyltrichlorosilane, 3-chloropropyltrimethoxysilane, vinyltriethoxysilane, vinylmethoxysilane, vinyl-tris(β-methoxyethoxy)silane, gamma-methacryloxypropyltrimethoxysilane, vinyltriacetoxysilane, divinyldichlorosilane, dimethylvinylchlorosilane, octyl-trichlorosilane, decyl-trichlorosilane, nonyl-trichlorosilane, (4-i-propylphenyl)-trichlorosilane, (4-t-butylphenyl)-trichlorosilane, dipentyl-dichlorosilane, dihexyl-dichlorosilane, dioctyl-dichlorosilane, dinonyl-dichlorosilane, didecyl-dichlorosilane, didodecyl-dichlorosilane, dihexadecyl-dichlorosilane, (4-t-butylphenyl)-octyl-dichlorosilane, dioctyl-dichlorosilane, didecenyl-dichlorosilane, dinonenyl-dichlorosilane, di-2-ethylhexyl-dichlorosilane, di-3,3-dimethylpentyl-dichlorosilane, trihexyl-chlorosilane, trioctyl-chlorosilane, tridecyl-chlorosilane, dioctyl-methyl-chlorosilane, octyl-dimethyl-chlorosilane, (4-i-propylphenyl)-diethyl-chlorosilane, octyltrimethoxysilane, hexamethyldisilazane, hexaethyldisilazane, diethyltetramethyldisilazane, hexaphenyldisilazane, and hexatolyldisilazane. In addition thereto, representative examples of the hydrophobizing agents include, but are not limited to, a titanate coupling agent and an aluminum coupling agent.

A general powder mixer is used for mixing the above external additives, and preferably equips a jacket or the like to adjust an internal temperature. For example, a V-type mixer, a rocking mixer, a Loedige mixer, a Nauta mixer, a Henschel mixers and the like are preferably used.

When the above inorganic fine particles and resin fine particles are contained (internally added) in the toner, an effect is less obvious than being externally added, but it is possible to obtain an effect of improving transferability and durability, and also to improve the pulverizability of the toner. Combination of the external adding and the internal adding makes it possible to suppress the externally added fine particles from being embedded, and thus, it is possible to stably obtain excellent transferability in the toner, and in addition, improve durability.

<<Other Components>>

The toner of the present disclosure may contain other components as appropriate depending on a purpose. Example of the other components include a fluidity improver, a cleanability improver, a magnetic material, and a metal soap.

There is provided the fluidity improver with which it is possible to apply surface-treatment to increase hydrophobicity to prevent deterioration of fluidity and a charging characteristic even under high humidity conditions. Examples of the fluidity improver include, but are not limited to, a silane coupling agent, a silylating agent, a silane coupling agent having a fluorinated alkyl group, an organic titanate-based coupling agent, an aluminum-based coupling agent, silicone oil, and modified silicone oil.

The cleanability improver may be added to the toner to remove a transferred developer remaining on an electrostatic latent image bearer or an intermediate transfer member.

Examples of the cleaning improver include, but are not limited to, zinc stearate, calcium stearate, fatty acid metal salt such as stearic acid, polymethyl methacrylate microparticles, and polymer microparticles produced by soap-free emulsion polymerization such as polystyrene microparticles. Such polymer microparticles preferably have a relatively narrow particle size distribution, and suitably have a weight average particle diameter of 0.01 to 1 μm.

The magnetic material is not particularly limited, and may be appropriately selected from well-known materials depending on a purpose, and examples thereof include, but are not limited to, iron powder, magnetite, and ferrite. In particular, a white magnetic material is preferable in terms of color tone.

The metal soap is not particularly limited and may be appropriately selected from well-known metal soaps depending on an intended purpose, and examples thereof include, but are not limited to, zinc stearate.

<<Toner Preparing Method>>

A method for preparing the toner of the present disclosure is not particularly limited, and includes a melt-kneading/pulverization method and a polymerization method, a polyaddition reaction method using an isocyanate group-containing prepolymer, a method in which toner materials are dissolved in a solvent, the solvent is then removed, followed by pulverizing, and a melt spray method.

Examples of the toner preparing methods include, but are not limited to, a melt-kneading method, a polymerization method (a suspension polymerization method/an emulsion polymerization method) in which a monomer composition containing a specific crystalline polymer and a polymerizable monomer is directly polymerized in an aqueous phase, a polyaddition reaction method in which a composition containing a specific crystalline polymer and an isocyanate group-containing prepolymer is directly extended/crosslinked by amines in an aqueous phase, and a method in which a toner is dissolved in a solvent, the toner is removed from the solvent, followed by pulverizing.

It is noted that as described above, in the toner of the present disclosure, it is preferable to use the toner in which a main component of the binder resin is a polyester resin.

In the melt-kneading/pulverization method, examples of a device for melting and kneading the toner preferably include, but are not limited to, two batch-type rolls, a banbury mixer or a continuous twin-screw extruder (for example, a KTK type twin-screw extruder manufactured by Kobe Steel, Ltd., a TEM-type twin-screw extruder manufactured by Toshiba Machine Co., Ltd., a twin-screw extruder manufactured by KCK, a PCM type twin-screw extruder manufactured by Ikegai Iron Works Co., Ltd., a KEX type twin-screw extruder manufactured by Kurimoto Iron Works Co., Ltd.) and a continuous single-screw kneader (for example, Co-Kneader manufactured by BUSS Co., etc.).

In the above polymerization method, and the polyaddition reaction method using an isocyanate group-containing prepolymer, forcible emulsification (formation of droplets) by imparting mechanical energy in an aqueous phase is essential. Examples of the unit imparting such mechanical energy include, but are not limited to, a unit of strong agitation such as a homo-mixer, ultrasonic waves, Manton-Gaulin or a unit applying ultrasonic vibration energy.

In the method of pulverization, it is possible to roughly pulverize the toner materials by using a hammer mill, Rotoplex, and the like, a fine pulverizer using a jet stream or a mechanical fine pulverizer may be used, and the pulverized material is desirably pulverized so that the average particle diameter is 3 to 15 μm. The pulverized material is adjusted to a particle size of 5 to 20 μm by an air classifier or the like.

A softening temperature (T_{1/2}: a temperature at which half of the sample flows out under a rising temperature and a predetermined load) as determined by a flow tester of the toner is suitably 115 to 140° C. From the viewpoint of toner storage stability, the glass transition temperature (Tg) is preferably 55 to 70° C., and more preferably 57 to 70° C. If the Tg is lower than 55° C., the toner tends to deteriorate in a high-temperature atmosphere, and offset may tend to occur during fixing. If the Tg exceeds 70° C., the fixability may deteriorate.

In the external addition of the external additive to the toner base, the toner base and the external additive are mixed and stirred by using a mixer or the like, the external additive is cracked and coated on the toner surface. At this time, it is important from the viewpoint of durability that the external additive such as inorganic fine particles and resin fine particles uniformly and firmly adheres to the toner base.

<<Developer>>

A developer using the toner of the present disclosure may be either a single component developer or a two-component developer. For example, the two-component developer includes the toner of the present disclosure and a carrier.

The carrier is not particularly limited and may be appropriately selected from well-known carriers depending on a purpose, but a carrier including a core material and a resin layer covering the core material is preferable.

A material of the core material is not particularly limited and may be appropriately selected according to a purpose, and for example, a manganese-strontium (Mn—Sr)-based material of 50 emu/g or more and 90 emu/g or less, and a manganese-magnesium (Mn—Mg)-based material are preferable, and in terms of ensuring image density, a highly magnetic material such as iron powder (100 emu/g or more) and magnetite (75 emu/g or more and 120 emu/g or less) is preferred.

In terms of a feature that the impact on a photoconductor when the toner is in a standing state can be weakened, which is advantageous for high image quality, a weakly magnetized material such as a copper-zinc (Cu—Zn)-based material (30 emu/g or more and 80 emu/g or less) is preferred. Such weakly magnetized materials may be used singly or in combination with others.

A volume average particle diameter of the core material is preferably 25 μm or more and 200 μm or less.

A material of the resin layer is not particularly limited, may be appropriately selected according to a purpose, and examples thereof include, but are not limited to, an amino resin, a polyvinyl resin, a polystyrene resin, a halogenated olefin resin, a polyester resin, a polycarbonate resin, a polyethylene resin, a polyvinyl fluoride resin, a polyvinylidene fluoride resin, a polytrifluoroethylene resin, a polyhexafluoropropylene resin, a copolymer of vinylidene fluoride and an acrylic monomer, a copolymer of vinylidene fluoride and vinyl fluoride, a fluoroterpolymer such as a terpolymer of tetrafluoroethylene, vinylidene fluoride, and a non-fluorinated monomer, and a silicone resin. Such resins may be used alone or in combination with others.

In a blending ratio of the toner and the carrier in the two-component developer, the blending amount of the toner with respect to the carrier is preferably 2.0% by mass or more and 12.0% by mass or less, and more preferably 2.5% by mass or more and 10.0% by mass or less.

<<Toner Housing Unit>>

The toner of the present disclosure may be housed and used in a toner housing unit. Here, the toner housing unit is a unit for housing the toner in a unit having a function of housing a toner. Examples of forms of the toner housing unit include, but are not limited to, a toner housing container, a developing device, and a process cartridge.

The toner housing container indicates a container in which the toner is housed.

The developing device indicates a device including a unit of housing and developing the toner.

The process cartridge indicates a cartridge that is obtained by integrating at least an image bearer and a developing unit, that houses the toner, and that is detachable from the image forming apparatus. The process cartridge may further include at least one selected from a charging unit, an exposure unit, and a cleaning unit.

The toner housing unit, which is attached to the below-described image forming apparatus to form an image to achieve an image formation by using the toner of the present disclosure, has excellent low-temperature fixability and heat-resistant storage stability, and provides an excellent image.

<<Process Cartridge>>

The toner of the present disclosure is used in the process cartridge. The process cartridge includes at least an electrostatic latent image bearer that bears an electrostatic latent image, and a developing unit that develops the electrostatic latent image born on the electrostatic latent image bearer by using the toner to form a visible image. The process cartridge further includes other units such as a charging unit, an exposure unit, a developing unit, a transfer unit, a cleaning unit, and a static eliminator unit, which are selected as appropriate.

The developing unit includes at least a developer container that contains the toner of the present disclosure or the developer described above, and a developer bearer that bears and transports the toner or the developer housed in the developer container, and may further include a layer thickness regulating member or the like that regulates a thickness of a toner layer to be born.

The process cartridge may be preferably detachably installed in various types of electrophotographic devices, facsimiles, and printers, and may be preferably detachably installed in the below-described image forming apparatus of the present disclosure.

<Image Formation Method and Image Forming Apparatus>

The image formation method of the present disclosure includes an electrostatic latent image forming step of forming an electrostatic latent image on an electrostatic latent image bearer, a developing step of developing the electrostatic latent image formed on the electrostatic latent image bearer with a pulverized toner to form a pulverized toner image, a transferring step of transferring the pulverized toner image formed on the electrostatic latent image bearer onto a surface of a recording medium, and a fixing step of fixing the pulverized toner image transferred onto the surface of the recording medium.

The image formation method of the present disclosure further includes another step such as a step of eliminating a static electricity, a cleaning step, a recycling step, and a controlling step, if desired.

The image forming apparatus according to the present disclosure includes an electrostatic latent image bearer, an electrostatic latent image formation unit that forms an electrostatic latent image on the electrostatic latent image bearer, a developing unit that develops the electrostatic latent image formed on the electrostatic latent image bearer with a pulverized toner to form a pulverized toner image, a transfer unit that transfers the pulverized toner image formed on the electrostatic latent image bearer onto a surface of a recording medium, and a fixing unit that fixes the pulverized toner image transferred onto the surface of the recording medium, and further, if desired, includes another unit such as a static eliminator unit, a cleaning unit, a recycling unit, and a control unit.

In the image formation method and the image forming apparatus of the present disclosure, the toner of the present disclosure is used as the pulverized toner.

Further, in a method of manufacturing a printed matter of the present disclosure, the image forming apparatus of the present disclosure is used to form the pulverized toner image with the toner of the present disclosure on a recording medium.

According to the method of manufacturing a printed matter of the present disclosure, the toner of the present disclosure, which is excellent in pulverizability, low-temperature fixability, and heat-resistant storage stability, is used, and thus, it is possible to obtain a printed matter in which a high-quality image is printed over a long period of time.

<<Electrostatic Latent Image Forming Step and Electrostatic Latent Image Formation Unit>>

The electrostatic latent image forming step included in the image formation method of the present disclosure is a step of forming an electrostatic latent image on an electrostatic latent image bearer. The electrostatic latent image bearer (hereinafter sometimes referred to as “electrophotographic photoconductor” or “photoconductor”) does not have any particular restrictions on its material, shape, structure, size, and the like and may be selected from among well-known carries.

The electrostatic latent image bearer suitably has a drum-shape. Examples of materials for the electrostatic latent image bearer include, but are not limited to, an inorganic photoconductor such as amorphous silicon and selenium, and an organic photoconductor (OPC) such as polysilane and phthalopolymethine. Among them, the material of the electrostatic latent image bearer is preferably the organic photoconductor (OPC) in that it is possible to obtain a higher definition image.

To form the electrostatic latent image, a surface of the electrostatic latent image bearer is uniformly charged, and subsequently, the resultant surface is exposed in an image pattern, and the electrostatic latent image is formed by the electrostatic latent image formation unit.

The electrostatic latent image formation unit includes at least a charging unit (charger) that uniformly charges the surface of the electrostatic latent image bearer and an exposure unit (exposure device) that exposes the surface of the electrostatic latent image bearer in an image pattern, for example.

When the surface is charged, the surface of the electrostatic latent image bearer is applied with voltage by using the charger, for example. The charger is not particularly limited and can be appropriately selected according to a purpose, and examples thereof may include, but are not limited to, a contact charger well-known per se including a conductive or semi-conductive roll, a brush, a film, a rubber and blades, and a non-contact charger using corona discharge such as corotron and scorotron.

A preferable charger is arranged in contact or non-contact with the electrostatic latent image bearer, and charges the surface of the electrostatic latent image bearer by superimposed application of DC and AC voltages. Further, a preferable charger is a charging roller arranged close to the electrostatic latent image bearer via a gap tape in a non-contact manner and charges the surface of the electrostatic latent image bearer by superimposed application of a DC voltage and an AC voltage on the charging roller.

When the surface is exposed, for example, the surface of the electrostatic latent image bearer is exposed in an image pattern by using an exposure device. The exposing device is not particularly limited as long as the exposure device can expose the surface of the electrostatic latent image bearer charged by the above-described charger in an image pattern to be formed, and may be appropriately selected according to a purpose. Examples of the exposing device include, but are not limited to, various exposing devices such as a copying optical system, a rod lens array system, a laser optical system, and a liquid crystal shutter optical system.

In the image formation method and the image forming apparatus of the present disclosure, it is possible to adopt a backside exposure method in which the surface is exposed in an image pattern from a rear surface side of the electrostatic latent image bearer.

<<Developing Step and Developing Unit>>

In the developing step, the electrostatic latent image is developed with the toner to form a visible image. The visible image may be formed, for example, by developing the electrostatic latent image with the toner of the present disclosure, and such processing may be performed by the developing unit.

A suitable developing unit includes a unit housing the toner of the present disclosure and including at least a developing unit that may apply the toner to the electrostatic latent image in a contact or non-contact manner, and a more preferable developer may include a container containing the toner.

The developing device may be a monochrome developing device, and a multicolor developing device, and an example of a suitable developing device may include a developing device including an agitator that frictionally agitates and charges the toner and a rotatable magnet roller.

<<Transferring Step and Transfer Unit>>

In the transferring step, a visible image is transferred onto a recording medium. In a preferable mode of the transferring step, an intermediate transfer body is used, the visible image is primarily transferred onto the intermediate transfer member, and subsequently, the visible image is secondarily transferred onto the recording medium. In the transferring step, two or more colors of toner, preferably full-color toner, are used. A more preferable mode of the transferring step includes a primary transferring step of transferring the visible image onto the intermediate transfer body to form a composite transferred image, and a secondary transferring step of transferring the composite transferred image onto the recording medium.

The transfer unit (the primary transfer unit and the secondary transfer unit) preferably includes at least a transfer device that separates and charge the visible image formed on the electrostatic latent image bearer (photoconductor) onto a recording medium side. The transfer unit may include one, or two or more transfer units.

Examples of the transfer device include, but are not limited to, a corona transfer device using corona discharge, a transfer belt, a transfer roller, a pressure transfer roller, and an adhesive transfer device.

The recording medium is not particularly limited, and may be appropriately selected from well-known recording media (recording sheet).

<<Fixing Step and Fixing Unit>>

In the fixing step, the visible image transferred onto the recording medium is fixed using the fixing device. The fixing step may be performed for a developing agent of each color each time the visible image is transferred to the recording medium, or may be performed simultaneously at one time when the developing agents of colors have been laminated.

The fixing device is not particularly limited and may be appropriately selected depending on a purpose, but a well-known heating and pressing unit is preferable. Examples of the heating and pressing unit include, but are not limited to, a combination of a heating roller and a pressure roller, a combination of a heating roller, a pressure roller, and an endless belt.

In the eliminating step, a static elimination bias is applied to the electrostatic latent image bearer to eliminate a static electricity, and such processing may be suitably performed by the static eliminator unit.

The static eliminator unit is not particularly limited as long as such a unit may apply a static electricity elimination bias to the electrostatic latent image bearer, and may be appropriately selected from well-known static eliminators. A preferable example thereof includes a static eliminator lamp.

In the cleaning step, the toner remaining on the electrostatic latent image bearer is removed, and such processing may be suitably performed by the cleaning unit.

The cleaning unit is not particularly limited as long as such a unit may remove the toner remaining on the electrostatic latent image bearer, and may be appropriately selected from well-known cleaners. Examples of suitable cleaners include, but are not limited to, a magnetic brush cleaner, an electrostatic brush cleaner, a magnetic roller cleaner, a blade cleaner, a brush cleaner, and a web cleaner.

In the recycling step, the toner removed in the cleaning step is recycled for the developing unit, and such processing may be suitably performed by the recycling unit. The recycling unit is not particularly limited, and a well-known conveyance unit or the like may be used.

In the controlling step, each of the above-described steps is controlled, and each step may be suitably performed by the control unit.

The control unit is not particularly limited as long as such a unit may control the movement of each unit, may be appropriately selected according to a purpose, and examples thereof include, but are not limited to, a device such as a sequencer and a computer.

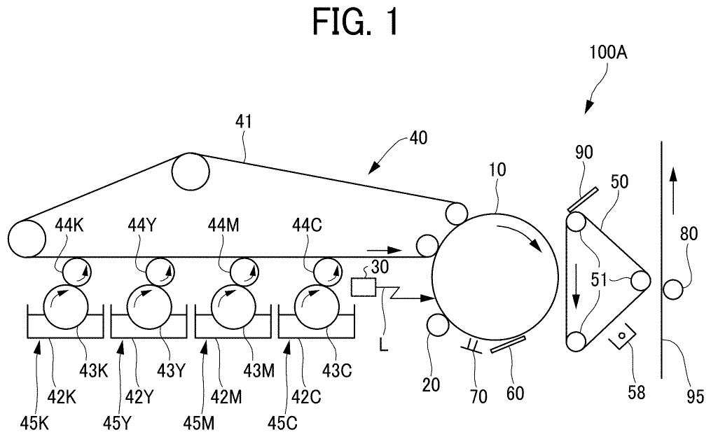

FIG. 1 is a schematic explanatory diagram illustrating an example (first embodiment) of the image forming apparatus of the present disclosure. An image forming apparatus 100A includes a photoconductor drum 10, a charging roller 20, an exposure device 30, a developing device 40, an intermediate transfer belt 50, a cleaning device 60 including a cleaning blade, and a static eliminator lamp 70. The photoconductor drum 10 is an example of the electrostatic latent image bearer.

The intermediate transfer belt 50 is an endless belt stretched to be laid by three rollers 51 arranged inside, and is movable in a direction indicated by an arrow in FIG. 1. One or two of the three rollers 51 also function(s) as transfer bias roller(s) applying a transfer bias (primary transfer bias) to the intermediate transfer belt 50.

A cleaning device 90 including a cleaning blade is arranged in the vicinity of the intermediate transfer belt 50. A transfer roller 80 that applies a transfer bias (secondary transfer bias) for transferring the toner image to a transfer sheet 95 is arranged to face the intermediate transfer belt 50.

A corona charging device 58 that applies an electric charge to the toner image transferred to the intermediate transfer belt 50, is arranged around the intermediate transfer belt 50. The corona charging device 58 is arranged between a contact unit between the photoconductor drum 10 and the intermediate transfer belt 50 and a contact unit between the intermediate transfer belt 50 and the transfer sheet 95, with respect to a rotation direction of the intermediate transfer belt 50 (arrow direction in FIG. 1).

The developing device 40 includes a developing belt 41, a black developing unit 45K provided together around the developing belt 41, a yellow developing unit 45Y, a magenta developing unit 45M, and a cyan developing unit 45C.

It is noted that the developing units 45 (developing units 45K, 45Y, 45M, and 45C) of the respective colors include a developing agent housing unit 42 (developing agent housing units 42K, 42Y, 42M, and 42C), a developing agent supply roller 43 (developing agent supply rollers 43K, 43Y, 43M, and 43C), and a developing roller (developer bearers) 44 (developing rollers 44K, 44Y, 44M, and 44C). The developing belt 41 is an endless belt stretched to be laid by a plurality of belt rollers, and is movable in the arrow direction in FIG. 1. A part of the developing belt 41 contacts the photoconductor drum 10.

Next, a method of forming an image by using the image forming apparatus 100A will be described below. Firstly, the charging roller 20 is used to uniformly charge the surface of the photoconductor drum 10 and an exposure device 30 is used to irradiate the surface of the photoconductor drum 10 with exposure light L to form an electrostatic latent image. Next, the electrostatic latent image formed on the photoconductor drum 10 is developed with the toner supplied from the developing device 40 to form the toner image.

Further, the toner image formed on the photoconductor drum 10 is transferred (primarily transferred) onto the intermediate transfer belt 50 by a transfer bias applied from the roller 51, and subsequently, transferred (secondarily transferred) onto the transfer sheet 95 by a transfer bias applied from the transfer roller 80. On the other hand, the photoconductor drum 10 in which the toner image is transferred to the intermediate transfer belt 50 has the toner remaining on the surface removed by the cleaning device 60, and subsequently, destaticized by the static eliminator lamp 70.

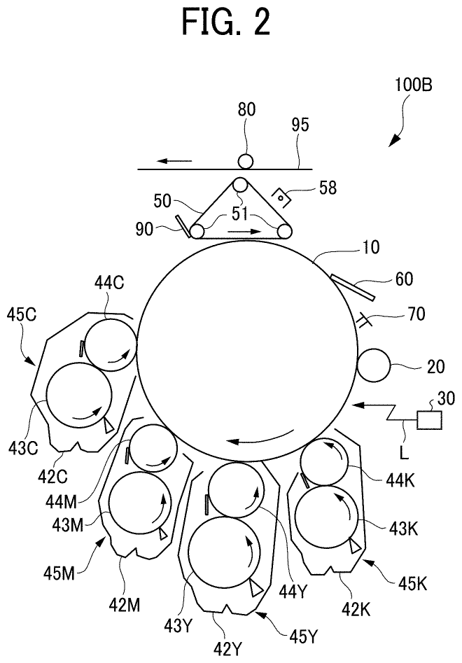

FIG. 2 illustrates another example (second embodiment) of the image forming apparatus used in the present disclosure. An image forming apparatus 100B is configured in much the same way as the image forming apparatus 100A except that the developing belt 41 is not provided, and around the photoconductor drum 10, the black developing unit 45K, the yellow developing unit 45Y, the magenta developing unit 45M, and the cyan developing unit 45C are arranged directly to face one another.

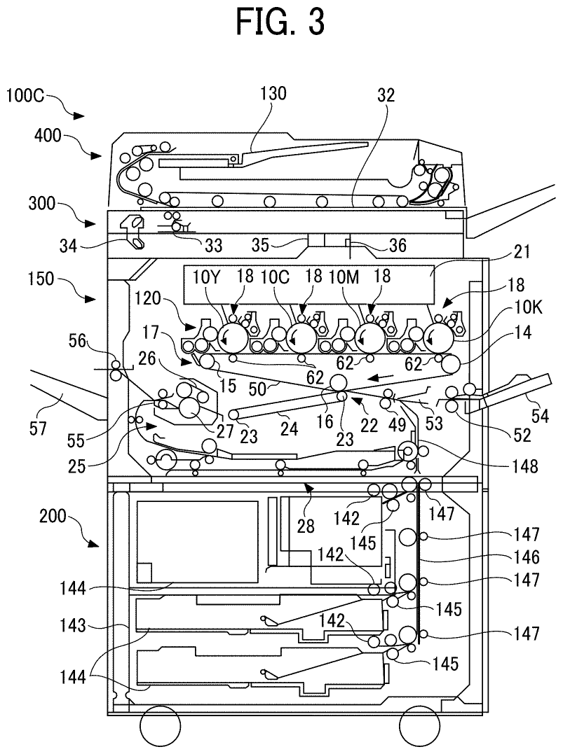

FIG. 3 illustrates another example (a third embodiment) of the image forming apparatus used in the present disclosure. An image forming apparatus 100C is a tandem-type full-color image forming apparatus, and includes a copier main body 150, a sheet feeding table 200, a scanner 300, and an automatic document feeder (ADF) 400.

An intermediate transfer belt 50 arranged at the center of the copier main body 150 is an endless belt stretched to be laid by the three rollers 14, 15, and 16, and is movable in a direction indicated by an arrow in FIG. 3.

In the vicinity of the roller 15, a cleaning device 17 including a cleaning blade for removing the toner remaining on the intermediate transfer belt 50 from which the toner image has been transferred onto the recording sheet, is arranged. Yellow, cyan, magenta, and black image formation units 120 (image formation units 120Y, 120C, 120M, and 120K) are arranged side by side along a transport direction to face the intermediate transfer belt 50 stretched to be laid by the rollers 14 and 15.

In the vicinity of the image formation unit 120, an exposure device 21 is arranged. A secondary transfer device 22 is arranged on the opposite side where the image formation unit 120 is arranged relative to the intermediate transfer belt 50. The secondary transfer device 22 includes a pair of rollers 23 and a secondary transfer belt 24.

The secondary transfer belt 24 is an endless belt stretched to be laid by the pair of rollers 23, and the recording sheet conveyed on the secondary transfer belt 24 and the intermediate transfer belt 50 are contactable between the rollers 16 and 23.

In the vicinity of the secondary transfer belt 24, a fixing device 25 including a fixing belt 26 being an endless belt stretched over a pair of rollers and a pressure roller 27 arranged to be pressed against the fixing belt 26, is arranged. In the vicinity of the secondary transfer belt 24 and the fixing device 25, a sheet reversing device 28 that reverses the recording sheet in a case of forming images on both surfaces of the recording sheet, is arranged.

Next, a method of forming a full-color image by using the image forming apparatus 100C will be described below. Firstly, a color document is set on a document platen 130 of the automatic document feeder (ADF) 400, or the automatic document feeder 400 is opened to set the color document on a contact glass 32 of the scanner 300, and the automatic document feeder 400 is closed.

When a start switch is depressed, a first traveling body 33 including a light source and a second traveling body 34 including a mirror travel in a case where the document is set on the automatic document feeder 400, after the document is conveyed to be moved on the contact glass 32, and on the other hand, in a case where the document is set on the contact glass 32, the scanner 300 is immediately driven.

At this time, when reflected light arriving from a document surface and being from light irradiated from the first traveling body 33 is received, after being reflected by the second traveling body 34, via an imaging forming lens 35 with a reading sensor 36, the document is read so that image information about black, yellow, magenta, and cyan is obtained. The image information of each color is transmitted to a corresponding image formation unit 18 in the image information unit 120 of each color, and the toner image of each color is formed.

The image formation unit 120 of each color respectively includes a photoconductor drum 10 (photoconductor drums 10K, 10Y, 10M, and 10C), a charging roller that uniformly charges the photoconductor drum 10, an exposure device 21 that illuminates the photoconductor drum 10 with the exposure light L (see FIGS. 1 and 2) based on image information of each color to form an electrostatic latent image of each color, a developing device that develops the electrostatic latent image with a developing agent of each color to form a toner image of each color, a transfer roller 62 that transfers the toner image onto the intermediate transfer belt 50, a cleaning device including a cleaning blade, and a static eliminator lamp.

The toner image of each color formed in the image formation unit 120 of each color is sequentially transferred (primarily transferred) onto the intermediate transfer belt 50 stretched over and moved by the rollers 14, 15, and 16, and overlaid so that a composite toner image is formed.

In the sheet feeding table 200, one of sheet feeding rollers 142 is selectively rotated to feed a recording sheet from one of sheet feeding cassettes 144 provided in a plurality of stages in a sheet bank 143. Next, the sheet is separated one by one by a separation roller 145 and sent to a sheet feeding path 146, conveyed by a conveyance roller 147, guided to a sheet feeding path 148 in the copying apparatus main body 150, and abutted against a registration roller 49 allowing the sheet to not move forward.

Alternatively, the feeding roller is rotated to feed the recording sheet on a manual sheet feeding tray 54, separated one by one by a separation roller 52, guided to a manual-feeding sheet feeding path 53, and abutted against the registration roller 49 allowing the sheet to not move forward. It is noted that the registration roller 49 is generally grounded and used, but the registration roller 49 may be used to be applied with a bias for removing paper powders from the recording sheet.

Next, the registration roller 49 is rotated at the same timing with the composite toner image formed on the intermediate transfer belt 50 to send the recording sheet to between the intermediate transfer belt 50 and the secondary transfer belt 24 so that the composite toner image is transferred (secondarily transferred) onto the recording sheet. It is noted that the toner remaining on the intermediate transfer belt 50 onto which the composite toner image is transferred is removed by the cleaning device 17.

The recording sheet onto which the composite toner image is transferred is conveyed by the secondary transfer belt 24, and subsequently, the recording sheet is fixed with the composite toner image by the fixing device 25. Next, the conveyance path for the recording sheet is switched by a switching claw 55, and the recording sheet is discharged onto the sheet ejection tray 57 by a discharge roller 56. Alternatively, the conveyance path for the recording sheet is switched by the switching claw 55, the recording sheet is reversed by the sheet reversing device 28, the bottom surface of the recording sheet is similarly formed with the image, and subsequently, the resultant recording sheet is discharged onto the sheet ejection tray 57 by the discharge roller 56.

According to the image forming apparatus and the image formation method of the present disclosure, it is possible to provide a high-quality image for a long period of time because the toner of the present disclosure excellent in low-temperature fixability and heat-resistant storage stability is used.

### EXAMPLES

The present disclosure will be described more specifically with reference to examples and comparative examples. It is noted that the present disclosure is not limited to these examples. In the following descriptions, “parts” represent “parts by mass” and “%” represents “% by mass”. Various types of tests and evaluations are carried out according to the following methods.

### Manufacturing Example

(Production of Non-Crystalline Polyester Resin 1)

Monomer species shown in Table 1 below and tetrabutoxytitanate serving as a condensation catalyst were placed into a reactor equipped with a condenser tube, a stirrer, and a nitrogen inlet tube, and the mixture was reacted at 230° C. for six hours under a stream of nitrogen while the resulting water to be produced was removed. Next, under reduced pressure of 5 mmHg to 20 mmHg, the mixture was reacted for one hour to obtain the non-crystalline polyester resin 1 used in Examples.

In Table 1 , “25 mol %” indicated in bisphenol A(2,2) ethylene oxide indicates a ratio in a diol component when an acid component is 50 mol % and an alcohol component is 50 mol %.

TABLE 1

| Acid Component | Diol Component | OH/COOH |
|---|---|---|
| Terephthalic Acid | Bisphenol A(2,2) | 1.1 |
| | Propylene oxide (5 mol %) | |
| | Bisphenol A(2,2) | |
| | Ethylene oxide (25 mol %) | |
| | Ethylene glycol (20 mol %) | |

(Production of Non-Crystalline Polyester Resin 2)

A non-crystalline polyester resin 2 was obtained in much the similar procedure as in the production of the non-crystalline polyester resin 1 except that the types of monomers used were changed as shown in Table 2 below.

TABLE 2

| Acid Component | Diol Component | OH/COOH |
|---|---|---|
| Terephthalic Acid | Bisphenol A(2,2) | 1.1 |
| | Propylene oxide (5 mol %) | |
| | Bisphenol A(2,2) | |
| | Ethylene oxide (25 mol %) | |

(Production of Crystalline Polyester 1)

Fumaric acid and 1,6-hexanediol were charged into a 5 L four-necked flask equipped with a nitrogen inlet tube, a dehydration tube, a stirrer, and a thermocouple so that the OH/COOH ratio of fumaric acid and 1,6-hexanediol was 0.9, the mixture, together with titanium tetraisopropoxide (500 ppm relative to the resin component), was reacted at 180° C. for ten hours, and subsequently, the temperature was raised to 200° C., and the mixture was reacted for three hours and further reacted for two hours at a pressure of 8.3 kPa to obtain a crystalline polyester with a melting point of 103° C.

(Production of Crystalline Polyester 2)

Fumaric acid and 1,6-hexanediol were charged into a 5 L four-necked flask equipped with a nitrogen inlet tube, a dehydration tube, a stirrer, and a thermocouple so that the OH/COOH ratio of fumaric acid and 1,6-hexanediol was 0.93, the mixture, together with titanium tetraisopropoxide (500 ppm relative to the resin component), was reacted at 180° C. for ten hours, and subsequently, the temperature was raised to 200° C., and the mixture was reacted for three hours and further reacted for two hours at a pressure of 8.3 kPa to obtain a crystalline polyester with a melting point of 117° C.

(Production of Crystalline Polyester 3) Fumaric acid and 1,6-hexanediol were charged into a 5 L four-necked flask equipped with a nitrogen inlet tube, a dehydration tube, a stirrer, and a thermocouple so that the OH/COOH ratio of fumaric acid and 1,6-hexanediol was 0.85, the mixture, together with titanium tetraisopropoxide (500 ppm relative to the resin component), was reacted at 180° C. for ten hours, and subsequently, the temperature was raised to 200° C., and the mixture was reacted for three hours and further reacted for two hours at a pressure of 8.3 kPa to obtain a crystalline polyester with a melting point of 97° C.

(Production of Crystalline Polyester 4)

Fumaric acid and 1,6-hexanediol were charged into a 5 L four-necked flask equipped with a nitrogen inlet tube, a dehydration tube, a stirrer, and a thermocouple so that the OH/COOH ratio of fumaric acid and 1,6-hexanediol was 0.96, the mixture, together with titanium tetraisopropoxide (500 ppm relative to the resin component), was reacted at 180° C. for ten hours, and subsequently, the temperature was raised to 200° C., and the mixture was reacted for three hours and further reacted for two hours at a pressure of 8.3 kPa to obtain a crystalline polyester with a melting point of 123° C.

### Examples and Comparative Examples

### Example 1

Preparation of Toner 1

Non-crystalline polyester resin 1: 77.5 parts

Crystalline polyester resin 1: 10 parts

Aromatic petroleum resin: styrene-based copolymer (manufactured by Mitsui Chemicals, Inc., FTR-2140) 7.5 parts

Wax: Fischer Tropsch wax (manufactured by Nippon Seiro Co., Ltd., FNP-0090) 5 parts

Carbon black (manufactured by Mitsubishi Kasei Corporation, #44): 10 parts

According to the above formulation, after a toner raw material was preliminarily mixed by using a Henschel mixer (manufactured by Mitsui Miike Kakoki Co., Ltd., FM20B), and subsequently, the mixture was melted and kneaded at a temperature of 120° C. with a twin-screw kneader (manufactured by Ikegai Iron Works Co., Ltd., PCM-30). The obtained kneaded product was rolled by a roller to have a thickness of 2.7 mm, and subsequently, cooled to a room temperature by a belt cooler and roughly pulverized by a hammer mill to have a diameter of from 200 to 300 μm.

Next, the resultant particles were finely pulverized by using a supersonic jet pulverizer Labjet (manufactured by Nippon Pneumatic Industry Co., Ltd.), and subsequently, classified while appropriately adjusting a louver opening to have a weight average particle diameter of 5.8±0.2 μm with an air classifier (manufactured by Nippon Pneumatic Industry Co., Ltd., MDS-I) to obtain toner base particles 1 of Example 1.

### Examples 2 to 9 and Comparative Examples 1 to 5

Preparation of Toners 2 to 14

Toners 2 to 14 of Examples 2 to 9 and Comparative Examples 1 to 5 were obtained in much the same procedure as in the Example 1 except that types and parts of the non-crystalline polyester resin to be used, types of the crystalline polyester resin to be used, types and parts of the aromatic petroleum resin to be used, and types of wax to be used were changed as in Table 3 below.

TABLE 3

| | | Toner formula | | | | | |
|---|---|---|---|---|---|---|---|
| | | Type of | Parts of | Type of | Type of | Parts of | |
| | | non-crystalline | non-crystalline | crystalline | aromatic | aromatic | |
| Ex. and | Toner | polyester | polyester | polyester | petroleum | petroleum | |
| Com. Ex. | Name | resin | resin | resin | resin | resin | Wax Type |
| Ex. 1 | Toner base | 1 | 77.5 | 1 | FTR-2140 | 7.5 | FNP-0090 |
| | particle 1 | | | | | | |
| Ex. 2 | Toner base | 1 | 79.5 | 1 | FTR-2140 | 5.5 | FNP-0090 |
| | particle 2 | | | | | | |
| Ex. 3 | Toner base | 1 | 77.5 | 2 | FTR-2140 | 7.5 | FNP-0090 |
| | particle 3 | | | | | | |
| Ex. 4 | Toner base | 1 | 77.5 | 3 | FTR-2140 | 7.5 | FNP-0090 |
| | particle 4 | | | | | | |
| Ex. 5 | Toner base | 1 | 77.5 | 4 | FTR-2140 | 7.5 | FNP-0090 |
| | particle 5 | | | | | | |
| Ex. 6 | Toner base | 1 | 77.5 | 1 | XR-1002 | 7.5 | FNP-0090 |
| | particle 6 | | | | | | |
| Ex. 7 | Toner base | 1 | 77.5 | 1 | FTR-8120 | 7.5 | FNP-0090 |
| | particle 7 | | | | | | |
| Ex. 8 | Toner base | 1 | 77.5 | 1 | XR-1001 | 7.5 | FNP-0090 |
| | particle 8 | | | | | | |
| Ex. 9 | Toner base | 1 | 77.5 | 1 | FTR-2140 | 7.5 | HNP-9 |
| | particle 9 | | | | | | |
| Com. | Toner base | 1 | 77.5 | — | FTR-2140 | 7.5 | FNP-0090 |
| Ex. 1 | particle 10 | | | | | | |
| Com. | Toner base | 1 | 77.5 | 1 | FTR-2140 | 7.5 | WE-11 |
| Ex. 2 | particle 11 | | | | | | |
| Com. | Toner base | 1 | 85 | 1 | — | — | FNP-0090 |
| Ex. 3 | particle 12 | | | | | | |
| Com. | Toner base | 1 | 81 | 1 | FTR-2140 | 4 | FNP-0090 |
| Ex. 4 | particle 13 | | | | | | |
| Com. | Toner base | 2 | 77.5 | 1 | FTR-2140 | 7.5 | FNP-0090 |
| Ex. 5 | particle 14 | | | | | | |

It is noted that the manufacturers, compositions, and physical property values of the aromatic petroleum resin and the wax to be used are shown in Tables 4 and 5 below.

TABLE 4

| | | | Weight |
|---|---|---|---|
| | | | Average |
| | | | Molecular |
| Material | | | weight |
| Name | Manufacturer | Material Type | (Mw) |
| FTR-2140 | Mitsui Chemicals, Inc. | Styrene-based copolymer | 3200 |
| FTR-8120 | Mitsui Chemicals, Inc. | Styrene-based copolymer | 1600 |
| XR-1001 | Seiko PMC Co., Ltd. | Styrene-based copolymer | 3600 |
| XR-1002 | Seiko PMC Co., Ltd. | Styrene acrylic resin | 3400 |

TABLE 5

| Material Name | Manufacturer | Wax Type |
|---|---|---|
| FNP-0090 | Nippon Seiro Co., Ltd. | Fischer Tropsch wax |
| HNP-9 | Nippon Seiro Co., Ltd. | Paraffin Wax |
| WE-11 | NOF Corporation | Synthetic ester wax |

(Preparation of Toner Developing Agent)

Relative to 100 parts by mass of the toner (toners 1 to 14), 1 part of metal oxide fine particles (HDK-2000 manufactured by Clariant) was stirred and mixed with a Henschel mixer to prepare an externally added toner. 5% of such an externally added toner and 95% of a coating ferrite carrier were uniformly mixed for five minutes at 48 rpm, by using a Turbula mixer (manufactured by Willy A. Bachofen (WAB)) to prepare a toner developing agent.

Using such a toner developing agent, low-temperature fixability, heat-resistant storage stability, durability, and blocking resistance were evaluated by the following evaluation methods.

(Pulverizability)

During manufacture of the toner base particles, a supersonic jet pulverizer Labjet (manufactured by Nippon Pneumatic Industry Co., Ltd.) was used to measure the weight average particle diameter after the particles were finely pulverized, and based on the following evaluation criteria, the pulverizability was evaluated. It is possible to determine based on results of evaluations A and B that practically, a good pulverizability is obtained.

Evaluation Criteria for Pulverizability

A: Less than 5.3 μm

B: 5.3 μm or more and less than 5.5 μm

C: 5.5 μm or more

(Low-Temperature Fixability)

The toner developing agent described above was placed in a copier (RICOH MPC 6003, manufactured by Ricoh Co., Ltd.), and an image was output. A solid image having an adhesion amount of 0.4 mg/cm² was subject to an exposure step, a development step, and a transfer step, and subsequently, was output on paper (Type 6200 manufactured by Ricoh Co., Ltd.). A linear velocity in the fixing step was set to 256 mm/sec. The image was sequentially output in increments of 5° C. of a fixing temperature, a lower limit temperature at which a cold offset would not occur (lower limit fixing temperature: low-temperature fixability) was measured. A NIP width of the fixing device was 11 mm.

Based on the following evaluation criteria, the low-temperature fixability was evaluated. It is possible to determine that the evaluations A and B indicate a practically good low-temperature fixability.

Evaluation Criteria for Low-Temperature Fixability

A: Lower than 120° C.

B: 120° C. or higher and lower than 130° C.

C: 130° C. or higher

(Heat-Resistant Storage Stability)

The toner base particles were stored under a condition of 50° C. for 24 hours, and the penetration was measured according to JIS K2235 (at 25° C.). A penetrometer VR-5610 (manufactured by Shimadzu Corporation) was used as a penetrometer. The heat-resistant storage stability was evaluated based on the following evaluation criteria. It is possible to determine that the evaluations A and B indicate a practically good heat-resistant storage stability.

Evaluation Criteria for Heat-resistant Storage Stability

A: 4.0 mm or more

B: 0.5 mm or more and less than 4.0 mm

C: Less than 0.5 mm

(Durability)

A copier having low-temperature fixability (imagio MF-6550, manufactured by Ricoh Co., Ltd.) was used to copy 100,000 copies of a test chart with an image area of 6% to evaluate durability by the degree of decrease in the charge amount of the developing agent. Durability was evaluated based on the following evaluation criteria. It is possible to determine that the evaluations A and B indicate a practically good durability.

A: Excellent durability with very little decrease in charge amount

B: Excellent durability compared to conventional toner with a small decrease in charge amount

C: Low durability equal to or lower than that of conventional toner

(Blocking Resistance)

In the fixability evaluation, an image evaluated at the lower limit of fixation+10° C. was cut to 2 cm×5 cm, and image planes were overlaid to be set into a slide glass. A 50 ml ointment bottle containing 60 g of ferrite carrier was placed on a slide glass and left for 24 hours while changing a storage temperature. Subsequently, after cooling for one hour, a peeling condition of the image was confirmed. Ranking was determined by a temperature at which the image peeling disappeared.

Blocking resistance was evaluated based on the following evaluation criteria. It is possible to determine that the evaluations A and B indicate a practically good blocking resistance.

A: A temperature at which image peeling disappears is 75° C. or higher

B: A temperature at which image peeling disappears is 70° C. or higher and lower than 75° C.

C: A temperature at which image peeling disappears is lower than 70° C.

Evaluation results of each toner are shown in Table 6 below.

TABLE 6

| | | | Low- | | | |
|---|---|---|---|---|---|---|
| Ex. and | Toner | | temperature | Heat | | Blocking |
| Com. Ex. | Name | Pulverizability | Fixability | Resistance | Durability | Resistance |
| Ex. 1 | Toner 1 | A | A | A | A | A |
| Ex. 2 | Toner 2 | A | A | B | B | A |
| Ex. 3 | Toner 3 | A | A | A | A | A |
| Ex. 4 | Toner 4 | A | B | A | A | A |
| Ex. 5 | Toner 5 | A | B | A | A | A |
| Ex. 6 | Toner 6 | A | A | B | B | A |
| Ex. 7 | Toner 7 | A | A | A | B | A |
| Ex. 8 | Toner 8 | B | A | A | A | A |
| Ex. 9 | Toner 9 | A | A | B | A | B |
| Com. | Toner 10 | A | C | A | A | A |
| Ex. 1 | | | | | | |
| Com. | Toner 11 | A | A | C | A | C |
| Ex. 2 | | | | | | |
| Com. | Toner 12 | C | A | C | A | A |
| Ex. 3 | | | | | | |
| Com. | Toner 13 | A | A | C | C | A |
| Ex. 4 | | | | | | |
| Com. | Toner 14 | A | A | A | C | A |
| Ex. 5 | | | | | | |

Table 6 indicates that the toners of Examples 1 to 9 are excellent in pulverizability, low-temperature fixability, heat-resistant storage stability, durability, and blocking resistance.

In contrast, the toners of Comparative Examples 1 to 5 were inferior in at least one of pulverizability, low-temperature fixability, heat-resistant storage stability, durability, and blocking resistance.

Embodiments of the present disclosure has been described above. However, the present disclosure is not limited to a specific embodiment, and various modifications and changes are possible within the scope of the invention described in the claims.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A toner, comprising:
a non-crystalline polyester resin;
a crystalline polyester resin;
a hydrocarbon wax; and
an aromatic petroleum resin,
a mass ratio of the aromatic petroleum resin to the hydrocarbon wax being 1.0 or more, and
the non-crystalline polyester resin containing diol components, the diol components including an alkylene oxide adduct of bisphenol A and ethylene glycol.

2. The toner according to claim 1, wherein the alkylene oxide adduct of bisphenol A is at least one of an ethylene oxide adduct of bisphenol A or a propylene oxide adduct of bisphenol A.

3. The toner according to claim 1, wherein the crystalline polyester resin has a melting point of 90° C. or higher and 130° C. or lower.

4. The toner according to claim 1, wherein the aromatic petroleum resin is a styrene-based copolymer.

5. The toner according to claim 1, wherein the aromatic petroleum resin has a weight average molecular weight of 1000 or more and 4000 or less.

6. The toner according to claim 1, wherein the hydrocarbon wax is Fischer Tropsch wax.

7. An image forming apparatus, comprising:
an electrostatic latent image bearer;
an electrostatic latent image formation unit configured to form an electrostatic latent image on the electrostatic latent image bearer;
a developing unit containing a pulverized toner, the developing unit configured to develop the electrostatic latent image formed on the electrostatic latent image bearer with the pulverized toner to form a pulverized toner image;
a transfer unit configured to transfer the pulverized toner image formed on the electrostatic latent image bearer onto a surface of a recording medium; and
a fixing unit configured to fix the pulverized toner image transferred onto the surface of the recording medium,
wherein the pulverized toner is the toner according to claim 1.

8. A printed matter manufacturing method, comprising:
forming a toner image with the toner according to claim 1 on a recording medium.

9. An image formation method, comprising:
forming an electrostatic latent image on an electrostatic latent image bearer;
developing the electrostatic latent image formed on the electrostatic latent image bearer with a pulverized toner to form a pulverized toner image;
transferring the pulverized toner image formed on the electrostatic latent image bearer onto a surface of a recording medium; and
fixing the pulverized toner image transferred onto the surface of the recording medium,
wherein the pulverized toner is the toner according to claim 1.
